(19) United States
(12) Patent Application Publication
(10) Pub. No.: US 2008/0141617 A1
(43) Pub. Date: Jun. 19, 2008

(54) Tile spacing tool

(76) Inventor: Christopher J. Joski, New Franken, WI (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/002,114

(22) Filed: Dec. 14, 2007

Related U.S. Application Data
(60) Provisional application No. 60/874,820, filed on Dec. 14, 2006.

(51) Int. Cl. E04F 21/20; G01B 5/00

(52) U.S. Cl. 52/749.11; 33/527

(57) ABSTRACT

A tile spacing tool is used to accurately space tile and comprises a first spacing rib having a top edge and a bottom edge and comprising a handle and a second spacing rib having a top edge and a bottom edge. The second spacing rib extends longitudinally along a perpendicular axis of the first spacing rib to form a generally cross-shaped horizontal spacing surface comprising the bottom edges of each of the first and second spacing ribs.

### CROSS-REFERENCE TO RELATED APPLICATION(S)

This application claims the benefit of U.S. Provisional Application No. 60/874,820 filed Dec. 14, 2006 by Christopher J. Joski.

### BACKGROUND

This invention relates to a tile spacing tool. More specifically, this invention relates to a tool, which is used to easily lay tile and ensures that the joint spacing between the tiles is accurate.

Laying tile is a tedious and time-consuming task. When laying tile it is extremely important to make certain that the tiles are accurately spaced with respect to one another. If the alignment is even a bit off, the results will look sloppy and unprofessional. In addition, many types of adhesive used to affix tile to a surface set up very quickly. For example, Duraceramic® is a type of flooring product with unique installation procedures that vary from that of ceramic or natural stone. Specifically, the type of adhesive used to install Duraceramic® bonds instantly to a surface. Therefore, it is imperative to properly position Duraceramic® prior to making contact with the laying surface. If a spacing mistake is made once the tile is bonded, it cannot be corrected.

As a result, efforts have been made to develop tools or devices which assist in accurately positioning tiles, such as tile spacers. Traditional tile spacers are small, cross-shaped plastic pieces, which are placed on the corner of each tile and act as a wedge between adjacent tiles. However, tile spacers have a number of disadvantages. First, it is difficult to accurately position the individual pieces. It is also challenging to ensure that the tile spacers remain in the correct position while laying adjacent tiles in place. Furthermore, when the adhesive is dry, a removal tool is needed to pry the spacers out from between the tiles.

Thus, there is a need in the art for a tool which allows tile to be laid easily and ensures that the joint spacing between the tiles is accurate.

### SUMMARY

The present invention is a tool used to accurately space tile. The present invention is a tile spacer, which comprises a first spacing rib having a top edge and a bottom edge and comprising a handle and a second spacing rib having a top edge and a bottom edge. The second spacing rib extends longitudinally along a generally perpendicular axis of the first spacing rib to form a generally cross-shaped horizontal spacing surface comprising the bottom edges of each of the first and second spacing ribs.

### BRIEF DESCRIPTION OF THE DRAWINGS

FIGS. 1A-1B are perspective views of an exemplary embodiment of a tile spacing tool.

FIG. 2A is a perspective view of the tile spacing tool shown spacing two tiles.

FIG. 2B is a top view of the tile spacing tool shown spacing two tiles.

FIG. 3 is a top view of the tile spacing tool shown spacing four tiles.

FIG. 4A is a side view showing possible dimensions of the tile spacing tool.

FIG. 4B is a top view showing possible dimensions of the tile spacing tool.

FIG. 4C is a perspective view of the tile spacing tool.

FIG. 5 is a perspective view of the tile spacing tool as used by an installer to space tile.

### DETAILED DESCRIPTION

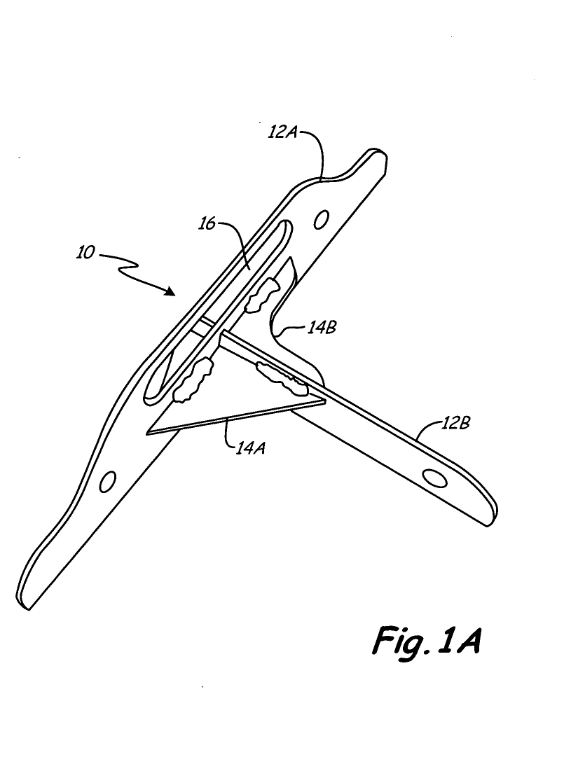

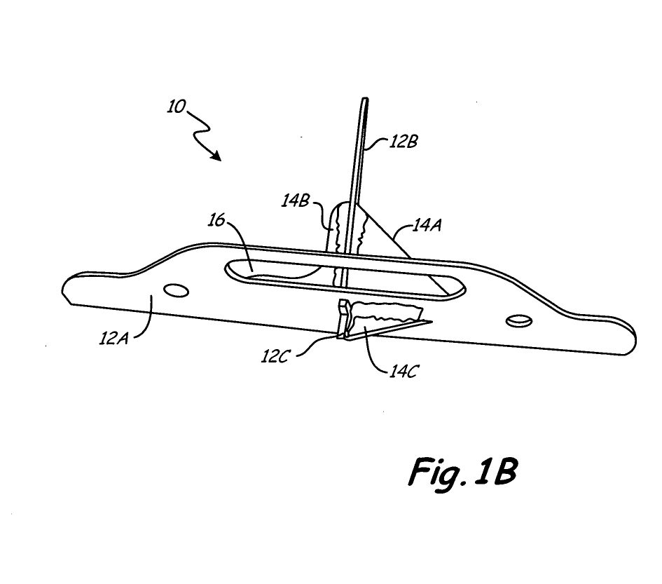

FIGS. 1A-1B are perspective views of an exemplary embodiment of tile spacing tool 10. Shown is tile spacing tool 10, which comprises first spacing rib 12A, second spacing rib 12B, third spacing rib 12C, first support joint 14A, second support joint 14B, third support joint 14C and handle 16.

First support joint 14A, second support joint 14B, third support joint 14C are arranged in a generally cross-shaped orientation. Second spacing rib 14B extends outward from first spacing rib 12A in a perpendicular direction to generally form two 90 degree angles with respect first spacing rib 12A. Third spacing rib 14C also extends outward from first spacing rib 12A in an opposite perpendicular direction to generally form two 90 degree angles with respect first spacing rib 12A. First spacing rib 12A comprises handle 16.

First support joint 14A and second support joint 14B are disposed between first and second support ribs 12A and 12B. Third support joint 14C is disposed between second support rib 12B and third support rib 12C. First, second, and third support joints 14A-14C ensure that first, second, and third support ribs 12A-12C remain properly positioned with respect to one another and maintain the integrity of the 90 degree angles, which are essential to accurate alignment.

As shown in FIGS. 1A-1B, tile spacing tool 10 is formed of individual aluminum parts, which are welded together. However, the invention is not so limited and any suitable material may be used. Tile spacing tool 10 may also be formed, for example, of a single unitary piece of molded metal or plastic.

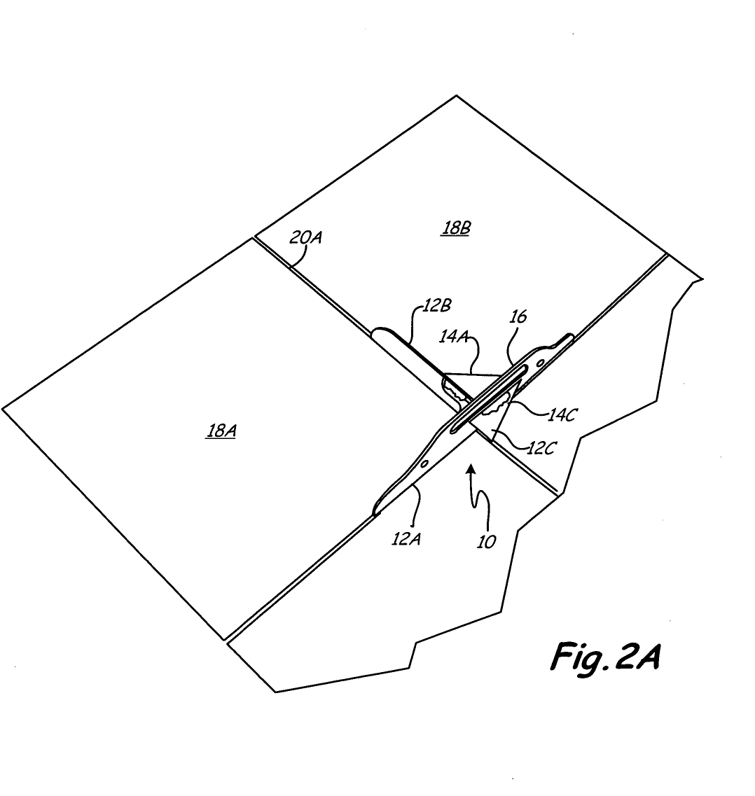

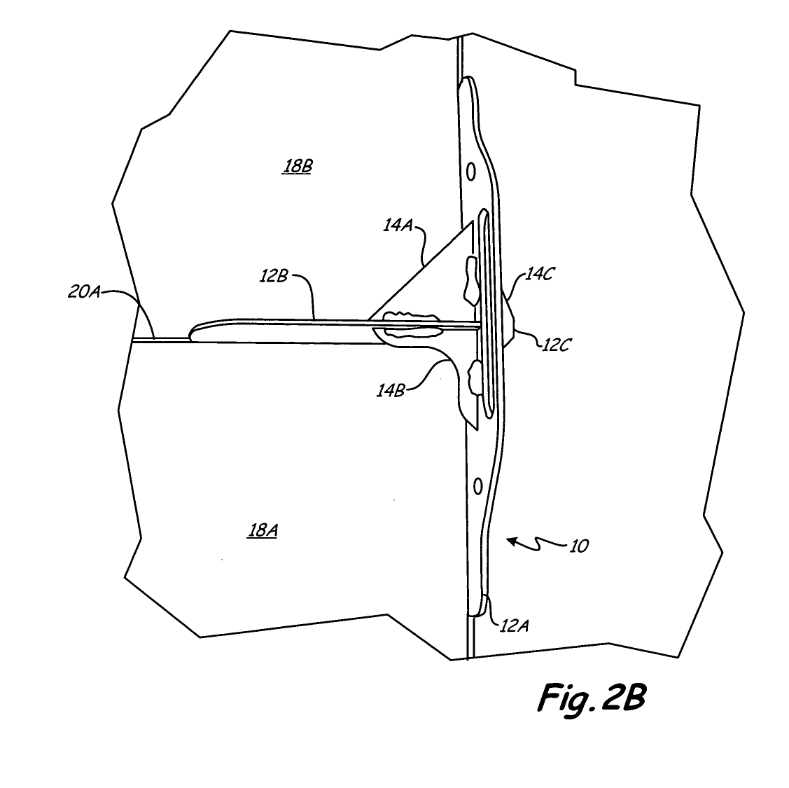

FIG. 2A is a perspective view and FIG. 2B is a top view of tile spacing tool 10 in use. Shown is tile spacing tool 10, which comprises first spacing rib 12A, second spacing rib 12B, third spacing rib 12C, first support joint 14A, second support joint 14B, third support joint 14C and handle 16. Also, shown are tiles 18A-18B and joint 20A.

As tile is laid it is extremely important to accurately space tiles with respect to one another. If the alignment or spacing between the tiles is even a little bit off, the end result will look sloppy and unprofessional. Therefore, it is necessary to ensure that the joints between tiles are uniformly spaced throughout the tile laying process.

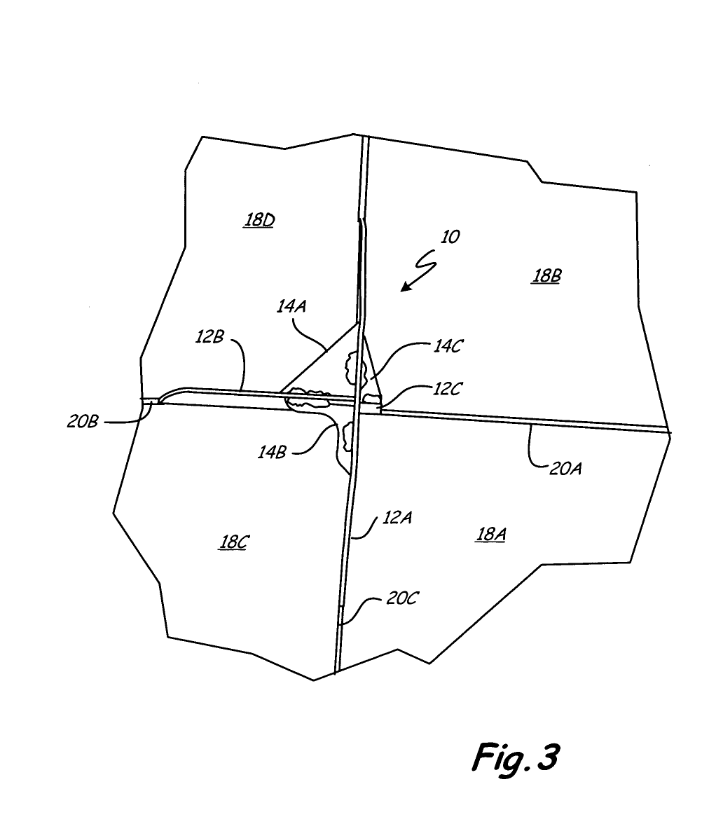

In FIGS. 2A-2B, tile spacing tool 10 is shown spacing tiles 18A-18B, which have a square shape. FIGS. 2 and 3A illustrate how tile spacing tool 10 may be used to accurately position and lay tiles 18A-18B. Tiles 18A-18B are spread with a suitable adhesive and placed side by side using tile spacing tool 10 as a guide. First spacing rib 12A fits snuggly against an edge of each tile 18A-18B. Second spacing rib 12B extends between tiles 18A-18B, and fits snuggly against an adjacent edge of each tile 18A-18B. Thus, tiles 18A-18B are aligned and second spacing rib 12B defines a uniform width for joint 20A, which runs in between tiles 18A-18B.

FIG. 3 is a top view of tile spacing tool 10 as used to space tiles 18A-18D. Also shown are joints 20A-20C.

Once tiles 18A-18B are properly positioned and laid, as described with reference to FIGS. 2A-2B, additional tiles may be added using tile spacing tool 10. As shown in FIG. 3, third spacing rib 12C is inserted into joint 20A, which extends between tiles 18A-18B, until an edge of each of tiles 18A-18B fits snuggly against first spacing rib 12A.

Tiles 18C-18D are then spread with adhesive and aligned with tiles 18A-18B using tile spacing tool 10. Tiles 18C-18D are positioned by placing an edge of each tile 18C-18D against a side of first spacing rib 12A (opposite the side of first spacing rib 12A against which an edge of each of tiles 18A-18B is positioned). An adjacent edge of each tile 18C-18D is placed against opposing sides of second spacing rib 12B. Thus, first spacing rib 12A defines a uniform width for joint 20C, which runs in between tiles 18A-18C and tile 18B-18D and second spacing rib 12B defines a uniform width for joint 20B, which extends between tiles 18C-18D.

As a result, tiles 18A-18D are easily and properly aligned and joints 20A-20C are uniformly spaced. Additional tiles may be added using the technique described in FIGS. 2A-2B and FIG. 3.

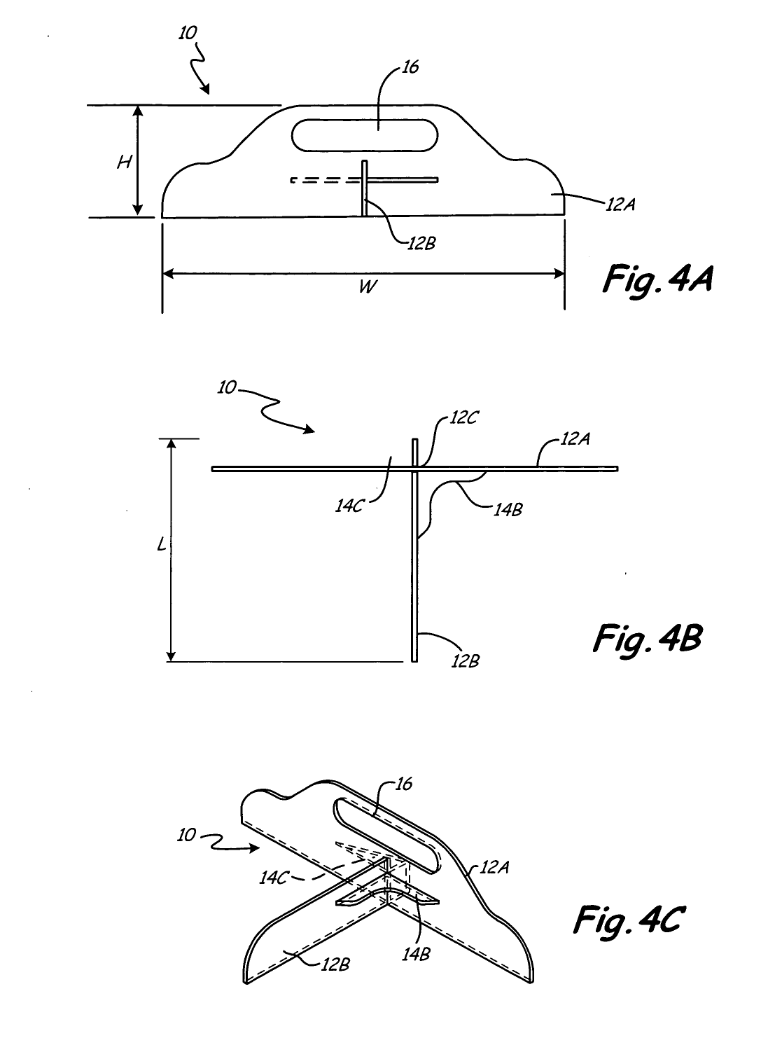

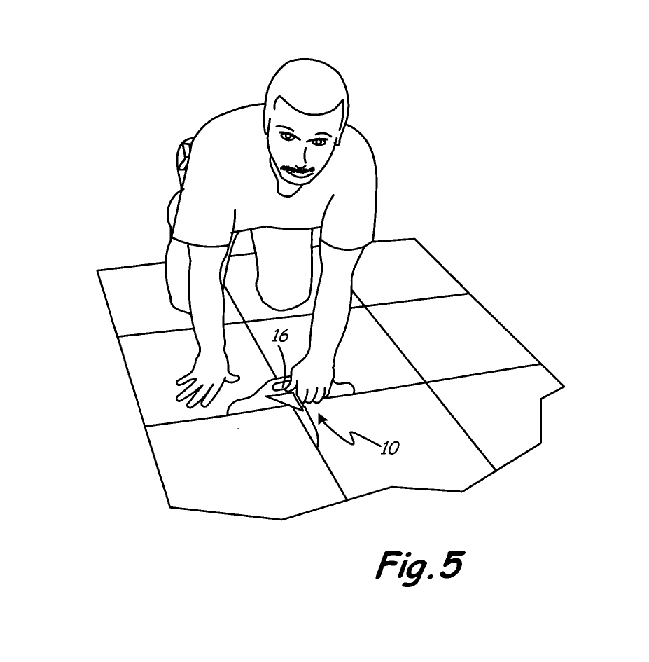

FIG. 4A is a side view and FIG. 4B is a top view showing possible dimensions of an exemplary embodiment of tile spacing tool 10. As shown in FIG. 4A, tile spacing tool 10 has a height of 4 inches, as indicated by line H and a width of 14.13 inches, as indicated by line W. As shown in FIG. 4B, tile spacing tool 10 may have a length of 9.5 inches, as indicated by line L. However, the invention is not so limited and tile spacing tool 10 may be configured to have any suitable dimensions. In addition, first, second, and third spacing ribs 12A-12C, shown in FIG. 4B, may each have a width of about 0.1 inches to about 1 inch. However, since first, second, and third spacing ribs 12A-12C define joints 20A-20C, as described with reference to FIG. 3, it is preferred that first, second, and third spacing ribs 12A-12C have identical widths.

FIG. 4C shows a perpendicular view of tile spacing tool 10. In the exemplary embodiment shown in FIGS. 4A-4C, support joint 14A is not used.

FIG. 5 is a perspective view of tile spacing tool 10 as used by an installer to space tile. As shown, tile spacing tool 10 is grasped by handle 16 and can be easily moved as needed. Tile spacing tool 10 is reusable and may be cleaned and stored for future use.

Although the present invention has been described with reference to preferred embodiments, workers skilled in the art will recognize that changes may be made in form and detail without departing from the spirit and scope of the invention. For example, in some cases the angles between the first and second ribs may not be exactly 90 degrees, but may be in a range of about 80 degrees to 100 degrees.

1. A tile spacing tool comprising:
a first spacing rib having a top edge and a bottom edge and comprising a handle; and
a second spacing rib having a top edge and a bottom edge, wherein the second spacing rib extends longitudinally in a first direction along a generally perpendicular axis of the first spacing rib to form a generally t-shaped horizontal spacing surface comprising the bottom edges of each of the first and second spacing ribs.

2. The tile spacing tool of claim 1 wherein the first spacing rib and the second spacing rib form two 90 degree angles with respect to one another.

3. The tile spacing tool of claim 2 and further comprising first and second support joints disposed between the first and second spacing ribs, respectively, which ensure that the first and second spacing ribs remain properly positioned with respect to one another and that the 90 degree angles are maintained.

4. The tile spacing tool of claim 1 wherein a third spacing rib having a top edge and a bottom edge extends longitudinally along the perpendicular axis of the first spacing rib in second direction opposite the first direction to form a generally cross-shaped horizontal spacing surface comprising the bottom edges of each of the first, second and third spacing ribs.

5. The tile spacing tool of claim 4 wherein the first spacing rib and the third spacing rib form two 90 degree angles with respect to one another.

6. The tile spacing tool of claim 5 and further comprising a third support joint disposed between the first and third spacing ribs, which ensures that the first and third spacing ribs remain properly positioned with respect to one another and that the 90 degree angle is maintained.

7. The tile spacing tool of claim 1 wherein the bottom edges of each of the first and second spacing ribs have a width of about 0.1 inches to about 1 inch.

8. The tile spacing tool of claim 1 wherein the tile spacing tool is comprised of a metal.

9. The tile spacing tool of claim 1 wherein the tile spacing tool is comprised of a plastic material.

10. The tile spacing tool of claim 1 wherein the tile spacing tool is reusable.

11. A tile spacing tool comprising:
a first spacing rib having a top edge and a bottom edge and comprising a handle; and
a second spacing rib having a top edge and a bottom edge, wherein the second spacing rib extends longitudinally in a first direction along a generally perpendicular axis of the first spacing rib to form a horizontal spacing surface comprising the bottom edges of each of the first and second spacing ribs.

12. The tile spacing tool of claim 11 wherein the first spacing rib and the second spacing rib form two angles ranging from about 80 degrees to about 100 degree s with respect to one another.

13. The tile spacing tool of claim 12 and further comprising first and second support joints disposed between the first and second spacing ribs, respectively, which ensure that the first and second spacing ribs remain properly positioned with respect to one another and that the angles are maintained.

14. The tile spacing tool of claim 11 wherein a third spacing rib having a top edge and a bottom edge extends longitudinally along the generally perpendicular axis of the first spacing rib in second direction opposite the first direction to form a generally cross-shaped horizontal spacing surface comprising the bottom edges of each of the first, second and third spacing ribs.

15. The tile spacing tool of claim 14 wherein the first spacing rib and the third spacing rib form two angles ranging from about 80 degrees to about 100 degrees with respect to one another.

16. The tile spacing tool of claim 15 and further comprising a third support joint disposed between the first and third spacing ribs, which ensures that the first and third spacing ribs remain properly positioned with respect to one another and that the angles are maintained.
